(19) United States
(12) Patent Application Publication
(10) Pub. No.: US 2011/0029659 A1
(43) Pub. Date: Feb. 3, 2011

(54) Method and System for Network Proxy Services for Energy Efficient Networking

(76) Inventor: Hemal Shah, Trabuco Canyon, CA (US)

Correspondence Address: MCANDREWS HELD & MALLOY, LTD, 500 WEST MADISON STREET, SUITE 3400, CHICAGO, IL, 60661, US

(21) Appl. No.: 12/845,343

(22) Filed: Jul. 28, 2010

Related U.S. Application Data
(60) Provisional application No. 61/230,363, filed on Jul. 31, 2009.

(51) Int. Cl. G06F 15/173; G06F 1/32

(52) U.S. Cl. 709/224; 713/321

(57) ABSTRACT

A network device may provide power-aware network proxy services to one or more resources internal to the network device and/or one or more other network devices that may transition to corresponding power saving states. The power saving states may comprise disabling, shutting down, and/or reducing power consumption. The power-aware network proxy service may comprise handling at least some of network communication on behalf of serviced internal resources and/or other network devices, and monitoring for conditions to transition the serviced internal resources and/or other network devices from the corresponding power saving states. The power-aware network proxy services may be provided via a network interface controller (NIC) in the network device. Determining when to transition serviced resources and/or other network devices from corresponding power saving states may be based on monitoring and/or processing of traffic handled on behalf of the serviced resources and/or other network devices during power-aware network proxy servicing.

### CROSS-REFERENCE TO RELATED APPLICATIONS/INCORPORATION BY REFERENCE

This patent application makes reference to, claims priority to and claims benefit from U.S. Provisional Application Ser. No. 61/230,363 (Attorney Docket No. 20854US01) which was filed on Jul. 31, 2009.

The above stated application is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to networking. More specifically, certain embodiments of the invention relate to a method and system for network proxy services for energy efficient networking.

### BACKGROUND OF THE INVENTION

Information Technology (IT) management may require performing remote management operations of remote systems to perform inventory and/or to determine whether remote systems are up-to-date. For example, management devices and/or consoles may perform such operations as discovering and/or navigating management resources in a network, manipulating and/or administrating management resources, requesting and/or controlling subscribing and/or unsubscribing operations, and executing and/or specific management methods and/or procedures. Management devices and/or consoles may communicate with devices in a network to ensure availability of remote systems, to validate that systems may be up-to-date, and/or to perform any security patch updates that may be necessary.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for network proxy services for energy efficient networking, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary network device that supports proxy services, in accordance with an embodiment of the invention.

FIG. 2A is a block diagram illustrating an exemplary network device comprising a network interface controller (NIC) being used as proxy to handle network discovery related traffic and/or other network management related traffic for the network device, in accordance with an embodiment of the invention.

FIG. 2B is a block diagram illustrating an exemplary network device being used as a proxy to handle network discovery related traffic and/or other network management related traffic for other network devices, in accordance with an embodiment of the invention, in accordance with an embodiment of the invention.

FIG. 3A is a flow chart that illustrates exemplary steps for providing network proxy services within a network device, in accordance with an embodiment of the invention.

FIG. 3B is a flow chart that illustrates exemplary steps for providing network proxy services by a network device to other network devices, in accordance with an embodiment of the invention.

### DETAILED DESCRIPTION OF THE INVENTION

Certain embodiments of the invention may be found in a method and system for network proxy services for energy efficient networking. In various embodiments of the invention, a network device may provide power-aware network proxy services to one or more resources internal to the network device and/or to one or more other network devices when the serviced internal resources and/or the one or more other network devices transition to one of a plurality of corresponding power saving states or from one of the plurality of power states to another of the plurality of power states. Exemplary network devices may comprise mobile communication devices, personal computers (PCs), servers, and/or network switches. Exemplary power saving states may comprise disabling, shutting down, and/or reducing power consumption of the serviced resources in the network device and/or other network devices. The power-aware network proxy service may enable handling of at least some network traffic pertaining to and/or communicated to and/or from serviced resources in the network device and/or other network devices. The power-aware network proxy service may also enable monitoring for conditions requiring transitioning of one or more the serviced resources in the network device and/or other network devices from a corresponding power state; and/or may transition one or more the serviced resources in the network device and/or the other network devices from a corresponding one of the power saving states based on that monitoring. The power-aware network proxy services may be provided via a network interface controller (NIC) in the network device, and/or via a dedicated component.

The determination of when to transition one or more of the serviced resources in the network device and/or other network devices from a corresponding power saving state may be based on monitoring and/or processing of traffic handled on behalf of the serviced resources in the network device and/or other network devices during the power-aware network proxy servicing. In this regard, a transition from a corresponding power saving state may be performed when handled traffic comprises actual data and/or management messages. Each of the serviced resources in the network device and/or other network devices may remain in a particular power saving state when handling discovery related traffic. The network device may trigger transitioning of one or more of the serviced resources in the network device and/or other network devices to a particular power saving state.

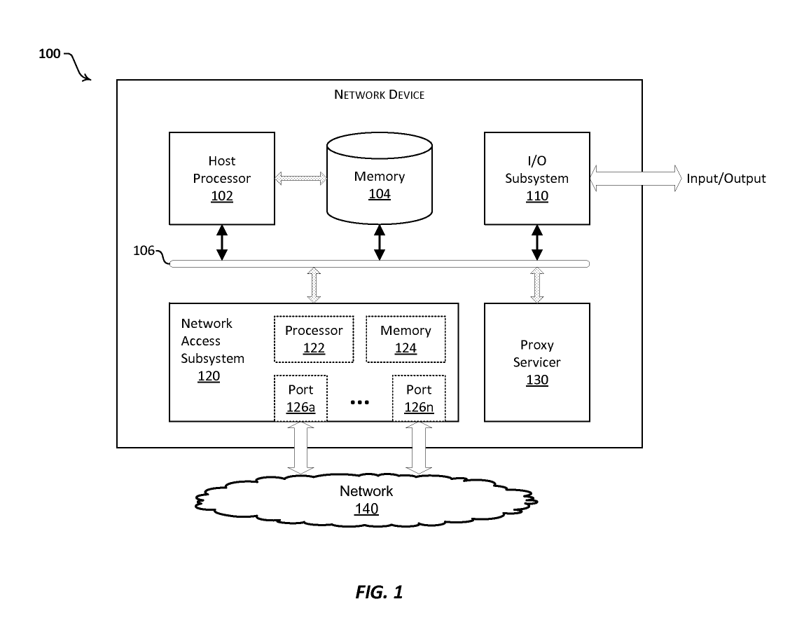

FIG. 1 is a block diagram illustrating an exemplary network device that supports proxy services, in accordance with an embodiment of the invention. Referring to FIG. 1, there is shown a network device 100, a host processor 102, a system memory 104, a system bus 106, an input/output (I/O) subsystem 110, a network access subsystem 120, a proxy servicer 130, and a network 140.

The network device 100 may comprise suitable logic, circuitry, interfaces, and/or code that may be operable to receive and/or send data, in the form of network traffic for example, via the network 140. The communicated data may be generated and/or destined for various tasks and/or applications executed in the network device 100, based on, for example, preloaded instructions and/or user input. Alternatively, the communicated data may originate from and/or be destined for other devices, for which the network device 100 may function as, for example, a traffic forwarding intermediary. Accordingly, the network device 100 may be a handheld mobile device, a personal computer (PC), a laptop, a server, a mainframe, a set-top-box, or a network router, switch, and/or bridge. During data communications to and/or from the network 140, the network device 100 may utilize network links. In this regard, the network links used by network device 100 may comprise Ethernet links, such as 10 Gigabit Ethernet (10 GbE) links.

The network device 100 may comprise the host processor 102, the system memory 104, the system bus 106, the I/O subsystem 110, the network access subsystem 120, and the proxy servicer 130. In this regard, the host processor 102 may provide overall control and/or management of the operations of the network device 100; the I/O subsystem 110 may enable user interactions with the network device 100; the network access subsystem 120 may enable communication of data and/or messages from and/or to the network device 100, when executing various tasks and/or applications; and the proxy servicer 130 may provide proxy services. The network device 100 may also comprise other hardware resources (not shown) such as a graphics card and/or a peripheral sound card, for example.

The host processor 102 may comprise suitable logic, circuitry, interfaces and/or code that may be operable to process data, and/or control and/or manage operations of the network device 100, and/or tasks and/or applications performed therein. In this regard, the host processor 102 may be operable to configure and/or control operations of various components and/or subsystems of the network device 100, by utilizing, for example, one or more control signals. The host processor 102 may also control data transfers within the network device 100. The host processor 102 may enable execution of applications, programs and/or code, which may be stored in the system memory 104 for example. The system memory 104 may comprise suitable logic, circuitry, interfaces and/or code that enable permanent and/or non-permanent storage and/or fetching of data, code and/or other information used in the network device 100. In this regard, the system memory 104 may comprise different memory technologies, including, for example, read-only memory (ROM), random access memory (RAM), and/or Flash memory. The system memory 104 may store, for example, configuration data, which may comprise parameters and/or code, comprising software and/or firmware, but the configuration data need not be limited in this regard.

The system bus 106 may comprise suitable logic, circuitry, interfaces, and/or code that may enable exchange of data and/or messages between various components and/or systems in the network device 100. In this regard, the system bus may comprise parallel or serial, and/or internal or external based bus technologies, and/or any combinations thereof. Exemplary system bus interfaces may comprise Inter-Integrated Circuit (I²C), Universal Serial Bus (USB), Advanced Technology Attachment (ATA), Small Computer System Interface (SCSI), Peripheral Component Interconnect (PCI), and/or Peripheral Component Interconnect Express (PCI-e) based interfaces.

The I/O subsystem 110 may comprise suitable logic, circuitry, interfaces, and/or code that may enable inputting and/or outputting of data and/or messages, to support user interactions with the network device 100, to receive user input and/or provide user output. For example, the I/O subsystem 110 may facilitate interactions with the network device 100 via one or more I/O devices, such as a monitor, a mouse, and/or keyboard.

The network access subsystem 120 may comprise suitable logic, circuitry, interfaces, and/or code that may be operable to communicate data and/or messages from and/or to the network device 100. The network access subsystem 120 may comprise, for example, a network interface controller or chip (NIC). The network access subsystem 120 may comprise, for example, the networking processor 122, the networking memory 124, and/or the plurality of ports 126a-226n. The networking processor 122 may comprise suitable logic, circuitry, interfaces, and/or code for controlling and/or managing operations of the network access subsystem 120. The networking memory 124 may comprise suitable logic, circuitry, and/or code for dedicated local storage and/or buffering of data within the network access subsystem 120. In this regard, the networking memory 124 may comprise one or more ROM and/or RAM memory devices. Each of the plurality of ports 126a-226n may comprise suitable logic, circuitry, interfaces, and/or code for providing network interfacing functionality, in the network access subsystem 120, based on one or more networking standards and/or protocols. The plurality of ports 126a-226n may comprise, for example, 10 GbE ports. The network access subsystem 120 may support and/or perform, for example, physical (PHY) layer related access, via the plurality of ports 126a-226n, and/or processing therefor. The network access subsystem 120 may also perform at least some switching, such as layer 2 (L2) based switching for example, during transmission and/or reception of data packets. The switching supported by the network access subsystem 120, however, need not be limited to L2, and may comprise L2, L3, L4, VLAN, and/or other protocol layer.

The network 140 may comprise a system of interconnected networks and/or devices for exchanging data among a plurality of nodes, based on one or more networking standards, including, for example, Internet Protocols (IP). The network 140 may comprise a plurality of subnetworks, which may comprise, for example, satellite networks, cable networks, DVB networks, storage area networks (SANs), the Internet, and/or other local or wide area network. These subnetworks may collectively enable communicating data, via Ethernet packets for example, to and/or from a plurality of end users. Physical connectivity within, and/or to or from the network 140, may be provided via copper wires, fiber-optic cables, wireless links, and/or other standards-based interfaces.

The proxy servicer 130 may comprise suitable logic, circuitry, interfaces, and/or code for providing network proxy servicing in the network device 100. In this regard, the proxy servicer 130 may be operable to act as networking proxy for other components in the network device 100 and/or for other network devices that may be communicatively coupled, directly or indirectly via other intermediary devices, with the network device 100. While the local manager 130 is shown as a separate component within the network device 100, the invention need not be so limited. For example, the proxy servicer 130 may be integrated into other components of the network device 100, and/or functions or operations described herein with respect to the proxy servicer 130 may be performed by other components of the network device 100, such as the network access subsystem 120 for example.

In operation, the proxy servicer 130 may be utilized to provide network proxying services to other components in the network device 100, and/or to other devices that may be communicatively coupled with the network device 100. An entity functioning as a network proxy may act on behalf of services entities and/or devices during networking operations, such as handling network traffic communicated to and/or from the serviced entities and/or devices. In this regard, the proxy servicer 130 may function, for example, on behalf of serviced components and/or devices as a proxy for network discovery related traffic, such as address resolution protocol (ARP), internet message control protocol (ICMP), and/or IPv6 neighbor discovery protocol based traffic for example. The proxy servicer 130 may independently generate responses to discovery requests and/or messages on behalf of serviced components and/or network devices. This may enable transitioning of serviced components and/or network devices to power-saving one of a plurality of power saving states. In this regard, serviced components and/or network devices may be disabled, shut down, and/or run minimally to reduce power consumption, with only the proxy servicer 130 remaining active and acting as a proxy for network discovery services.

The proxy servicer 130 may also provide similar servicing with respect to other types of traffic, such as management or data related traffic, which may also be handled by the proxy servicer 130 without necessitating transitioning serviced components and/or network devices out of power-saving states. In instances where it may be determined that the proxy servicer 130 may be incapable of handling the traffic autonomously, the proxy servicer 130 may trigger serviced components or network devices to transition out of the power-saving states. This may occur, for example, upon reception of actual data packets and/or particular management packets, which may indicate and/or require handling and/or processing only by the serviced components or network devices.

In various embodiments of the invention, the network device 100 may be utilized to implement a comprehensive end-to-end energy efficient network solution which may span a whole network. In this regard, the end-to-end energy efficient network solution may span, for example, all the way from data centers, to servers through any switches that may be traversed during, for example, data and/or management exchanges. The network proxying services may be provided at different nodes in the end-to-end path, preferable at devices that consume less power, to enable transitioning of a maximum number of devices and/or resources in a network into power-saving states, and/or to continue proxying these transitioned devices and/or resources while they are in the power-saving states. In this regard, a subset of networking operations typically performed by those resources and/or resources, such as discovery, may be offloaded to a servicing node, which may be substantially similar to the network device 100, and which may provide the network proxying services and/or which consume much less power. The serviced devices and/or resources may be awakened in instances when the servicing nodes receives traffic that may be determined to be beyond what may be handled by the servicing nodes.

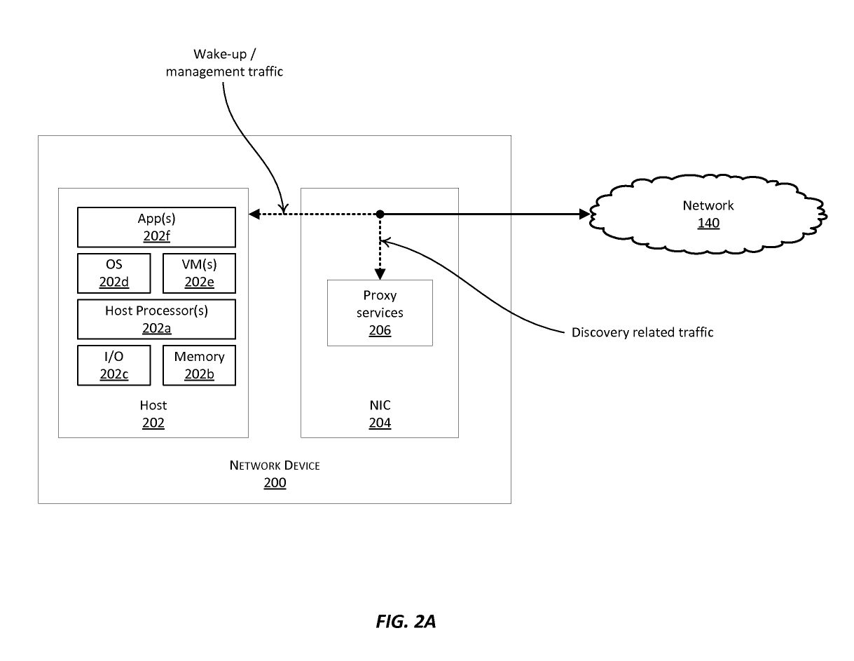

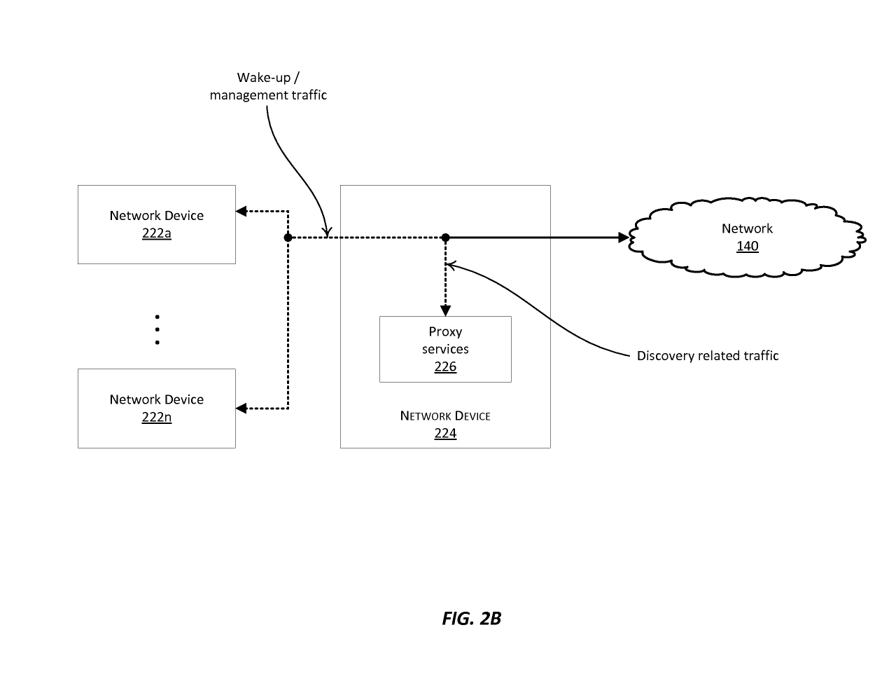

FIG. 2A is a block diagram illustrating an exemplary network device comprising a network interface controller (NIC) being used as proxy to handle network discovery related traffic and/or other network management related traffic for the network device, in accordance with an embodiment of the invention. Referring to FIG. 2A there is shown a network device 200 and the network 140. The network device 200 comprises a host 202 and a network interface controller (NIC) 204.

The network device 200 may be similar to the network device 100, substantially as described with respect to, for example, FIG. 1. In this regard, the network device 200 may be one or more of, for example, a computer, a server, a switch, and/or a router and may be operable to implement one or more layers of the Open Systems Interconnect (OSI) model. For example, the network device 200 may comprise, for example, one or more processors, controllers, memory/storage elements, field-programmable gate arrays (FPGAs), and/or application-specific integrated circuits (ASICs), which may be operable to implement, for example, the host 202 and/or the NIC 204.

The host 202 may correspond to components and/or subsystems in the network device 200, which may be used for running and/or executing processes, tasks, and/or applications which may be provided to, for example, device users. In this regard, the host 202 may comprise one or more general or dedicated processors 202a (e.g. CPU), one or more memories 202b, input/output components 202c. The host 202 may also comprise an operating system (OS) 202d and/or one or more virtual machines (VMs) 202e, which may provide an environment that may be operable to control and/or manage operation of various components of the network device 200 and/or to enable running and/or executing a plurality of applications 202f. In various embodiments of the invention, the host 202 may be enabled to operate in one or more of a plurality of states, and at least a subset of this plurality of states may comprise one or more power-saving states. During the one or more power saving states, one or more functions, components, and/or resources of the host 202 may be disabled, shut down, and/or run at minimal capability to reduce power consumption.

The NIC 204 may comprise suitable logic, circuitry, interfaces, and/or code that may be operable to perform one or more networking functions. In this regard, the NIC 204 may be similar and/or correspond to the network access system 120, substantially as described with regard to FIG. 1. The NIC 204 may be operable to implement, for example, one or more layers of the OSI model. For example, the NIC 204 may be operable to interface to an Ethernet network, and may provide physical (PHY) layer and/or media access controller (MAC) layer interfacing and/or processing operations. While the NIC 204 is shown as internal and/or integrated component of the network device 200, the invention need not be so limited. Accordingly, the NIC 204 may comprise a plug-in card or swappable module. In various embodiments of the invention, the NIC 204 may be enabled to operate in one or more of a plurality of states, and at least a subset of this plurality of states may comprise energy-saving states. During the one or more power saving states, one or more functions, components, and/or resources of the NIC 204 may be disabled, shut down, and/or run at minimal capability to reduce power consumption.

In an exemplary aspect of the invention, the NIC 204 may be operable to provide proxy services, via a proxy servicer module 206. The proxy servicer module 206 may be similar to the proxy servicer 130, substantially as described with regard to FIG. 1. In this regard, the proxy servicer module 206 may comprise suitable logic, circuitry, interfaces, and/or code to operate as a networking proxy for other components in the network device 200. For example, the proxy servicer 206 may operate as a proxy for network discovery and/or other management related traffic such as address resolution protocol (ARP), internet message control protocol (ICMP), and/or IPv6 neighbor discovery protocol. In this regard, the proxy servicer module 206 may generate responses to discovery and/or management related requests without assistance from the host 202 and/or without assistance from various portions of the NIC 204. For example, when the host 202 and/or the NIC 204 are operating in a power-saving state, the proxy servicer module 206 may be active and may act as a proxy for network discovery and/or management related services. In this manner, discovery and/or management related traffic may be handled by the proxy servicer module 206 without having to transition other portions of the NIC 204 and/or the host 202 out of a power-saving state. Additionally, the proxy servicer module 206 may trigger the host 202 and/or the NIC 204 to transition out of the power-saving state upon receiving actual data packets and/or particular management packets that indicate or require the host 202 and/or other portions of the NIC 204.

In operation, the network device 200 may support use of the power saving mechanisms to reduce energy consumption by the network device 200 and/or components thereof. In this regard, the network device 200, and/or some components, may support transitioning to power-saving states. During these power-saving states, the network device 200, and/or any components transitioned to these states, may be disabled, shut down, and/or run minimally to reduce power consumption. In an exemplary aspect of the invention, the NIC 204 may provide network proxying services, via a proxy servicer module 206, in the network device 200, in instances when the network device 200, or any components thereof, including the NIC 204 itself, may transition to power-saving states. For example, the host 202 and/or the NIC 204 may transition to power-saving states after a period of receiving and/or sending no data to and/or from the network 140, for example. This may occur in instances where the network device 200 establishes peer-to-peer connections via the network 140, and the other peer ceases to transmit data. This may also occur in instances where no user input is received for an application 202f running via one or more operating systems, for example, the OS 202d. Transitioning to power-saving state may be triggered by, for example, the proxy servicer module 206, which may, for example, monitor for conditions that necessitate and/or permit such transitions. Serviced components in the network device 200 may also determine when such transitions may be appropriate, and/or may inform the proxy servicer module 206, to trigger any such transition. The serviced components may also autonomously undertake any such transitions, and may only inform the proxy servicer module 206 of the transitions to enable the proxy servicer module 206 to initiate network proxying services on their behalf.

While in power-saving states, the proxy servicer module 206 may handle some of the networking operations that would otherwise have been handled by the serviced components themselves. For example, the proxy servicer module 206 may handle discovery related traffic, and may provide responses, if necessary, that may communicated on behalf of the serviced components, via the network 140.

Certain conditions and/or scenarios, however, such as reception via the network 140 of network management traffic and/or traffic carrying real data, may be beyond the scope of the network proxying capabilities and/or permissions of the proxy servicer module 206. Thus, the serviced components, such as the host 202 (or any serviced entities therein) and/or the NIC 204, may need to transition from the power-saving states, to active states for example. Accordingly, the proxy servicer module 206 may wake up the host 202 and/or the NIC 204, by triggering, for example, transitioning of the host 202 and/or the NIC 204 out of the power-saving states, to active states.

FIG. 2B is a block diagram illustrating an exemplary network device being used as a proxy to handle network discovery related traffic and/or other network management related traffic for other network devices, in accordance with an embodiment of the invention, in accordance with an embodiment of the invention. Referring to FIG. 2B there is shown network devices 222a-222n, a network device 224, and the network 140.

Each of the network devices 222a-222n and the network device 224 may be similar to the network device 100, substantially as described with respect to, for example, FIG. 1. In various embodiments of the invention, the network device 224 may be operable to provide aggregated power-aware network servicing, via a network proxy servicer module 226, for the plurality of network device 222a-222n. In this regard, each of the network devices 222a-222n may be operable to transition to power saving states, and the network device 224 may be operable to provide, via a network proxy servicer module 226 for example, network proxying serviced at least some of the network device 222a-222n that may transition to power saving states.

The network proxy servicer module 226 may be similar to the proxy servicer 130, substantially as described with regard to, for example, FIG. 1. The network proxy servicer module 226 may be operable to enable utilizing the network device 224 as network proxy on behalf of other network devices, such as one or more of the network devices 222a-222n, during networking operations, such as handling network traffic communicated to and/or from the serviced devices. In this regard, the network proxy servicer module 226 may function, for example, on behalf of serviced devices as a proxy for network discovery related traffic, such as address resolution protocol (ARP), Internet message control protocol (ICMP), and/or IPv6 neighbor discovery protocol based traffic for example. The network proxy servicer module 226, however, may not be able to handle some network traffic, for example, on behalf of serviced devices such as some network management traffic and/or network traffic that may carry actual data.

In operation, network proxying operations in a set of network devices, such as the network devices 222a-220n and 224, may be aggregated to enhance power saving. In this regard, rather than transitioning only components in network devices to power-saving states, with some components remaining active to handle networking operations on their behalf as network proxies, whole network devices may be transitioned to power-saving states with one or more other network devices providing network proxying services. For example, one ore more of the network devices 222a-222n may transition to a corresponding power-saving state after periods of no communication with the network 140, for example. While the network devices 222a-222n are in a corresponding power-saving mode, the network device 224 may function as a network proxy, to handle at least some of the network traffic on their behalf, such as some network management traffic and/or discovery related traffic, such that the network devices 222a-222n may not need to transition out of power-saving states in order to handle and/or respond to such traffic. In this regard, the network device 224 may intercept network management and/or discovery related traffic intended for the network devices 222a-222n and may handle the traffic via the network proxy servicer module 226. Accordingly, prior to transitioning into a power-saving mode, the network devices 222a-222n may coordinate the proxy services with the network device 224. For example, the network devices may provide the contents of one or more tables (e.g., ARP tables), parameters, or other information to the network device 224 to enable to network device 224 to function as a proxy for such traffic. Additionally, the network device 224 may also be operable to detect when communicated network traffic may require waking up certain network device, such as the network device 222a for example, and triggering the network device 222a to transition out of the power-saving mode upon receiving such traffic and/or prior to forwarding traffic to the network device 222a.

Configuration of the network device 224 and/or the 222a-222n for network proxying servicing may be performed based on network topology awareness. In this regard, determining the network device that may be provide network proxying services, such as the network device 224, for other network devices, such as the network devices 222a-222n, may be based on determining devices that may be higher within the network topology. For example, a network may comprise a plurality of servers whose network traffic may be communicated through different levels of switches, such as blade switches and then top-of-the-rack (ToR) switches. Accordingly, a ToR switch may be chosen for providing network proxying services for one or more blade switches and servers serviced through it, during switching operations, since traffic to and/or from these blade switches and servers traverses the ToR switch. Configuration of the network device 224 and/or the network devices 222a-222n for network proxying servicing may also be performed based on determining power consumption requirements and/or needs for providing these network proxying services. For example, the network device 224 may be chosen to provide network proxying service for the network devices 222a-222n based on a determination that the network device 224 would consume less power when providing these services than any other network device.

In various embodiments of the invention, the network proxying aggregation may be used in conjunction with network proxying operations within the network devices. In this regard, a two-level network proxying service may utilized such that in addition to providing network proxying service via the network device 224, network proxying services may provide, via internal network proxying services such as instances of the proxy servicer module 206 as described with regard to FIG. 2A, may utilized in one or more of the network devices 222a-222n to provide network proxying services within these devices.

In various embodiments of the invention, the network proxy servicer module 226 may be utilized to provide centralized management and/or control of network proxying services to the plurality of the network devices 222a-222n and 224. In this regard, network proxy servicer module 226 may maintain network proxying related database corresponding to the network device 224 and at least some of the network devices 222a-222n, to enhance the network proxying servicing. For example, network devices may be categorized and/or classified based on various parameters and/or information, such as power consumption and/or network topology, to enable determining one or more network devices that may provide network proxying services, when remaining network devices transition to power saving states. In this regard, the categorization and/or classification may be performed, via the network proxy servicer module 226 for example. Furthermore, the network proxy servicer module 226 may continually monitor the network devices 222a-2224 and 224 to update and/or modify the categorization and/or classification.

In an exemplary embodiment of the invention, the network proxy servicer module 226 may determine when serviced network devices transition to partial or full network proxying modes. In this regard, the network proxy servicer module 226 may determine that a network device, such as the network device 222a, may only transition to partial network proxying mode, wherein the network proxying servicing may be provided internally within the network device 222a, via an instance of the proxy servicer module 206. The network proxy servicer module 226 may determine that a network device, such as the network device 222n, may transition to full network proxying mode, wherein the network proxying servicing may be provided externally, via the network proxy servicer module 226 for example. The network proxy servicer module 226 may manage and/or control network proxying servicing based on preconfigured power consumption related information pertaining to the network device 224 and/or the network devices 222a-222n. The network proxy servicer module 226 may also manage and/or control network proxying servicing based real-time power consumption related information, which may be communicated by the network devices 222a-222n, for example, dynamically and/or in response to requests sent by the network proxy servicer module 226.

Transitioning the network devices 222a-222n to power-saving states may be triggered by, for example, the network proxy servicer module 226. In this regard, the network proxy servicer module 226 may, for example, monitor for conditions that necessitate and/or permit such transitions. Once conditions necessitating and/or permitting such transitions are determined, the network proxy servicer module 226 may instruct the corresponding network device, such the network device 222a for example, to transition to a power saving state, which may correspond to partial or full network proxying. The serviced network devices may also determine when transitions to power saving states may be appropriate, and may inform the network proxy servicer module 226, to trigger such transition. The serviced network devices may also undertake any such transitions autonomously, and may only inform the network proxy servicer module 226 of the transitions to enable the network proxy servicer module 226 to initiate network proxying services on their behalf.

In various embodiments of the invention, a dedicated network proxying related interface may be utilized between the network proxy servicer module 226 and the serviced network devices 222a-222n. In this regard, the dedicated network proxying related interface may comprise a dedicated protocol defining network proxying service related messages that may be exchanged. Alternatively, network proxying service related message may be encapsulated in typical network messages, using TCP/IP packets for example.

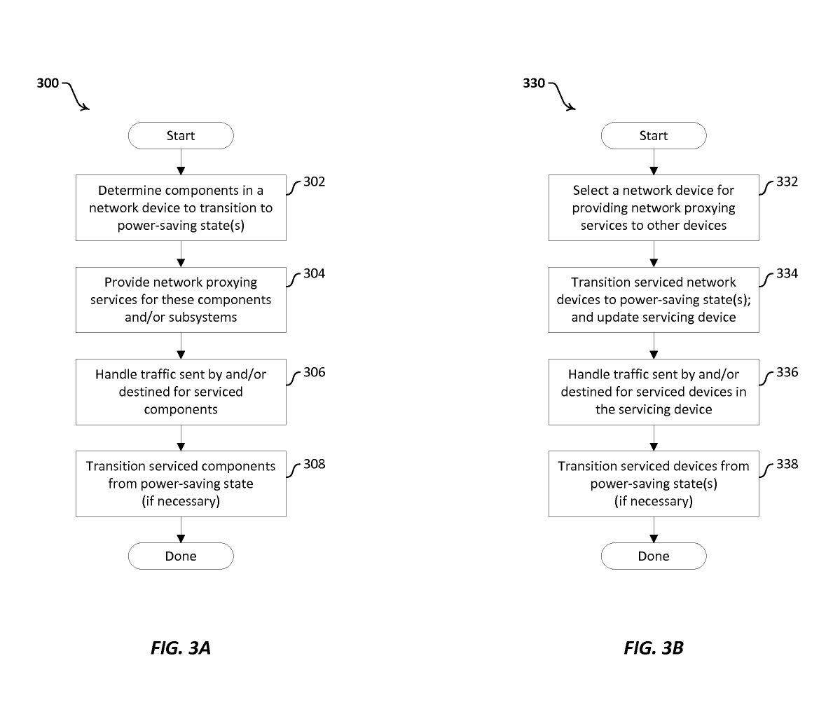

FIG. 3A is a flow chart that illustrates exemplary steps for providing network proxy services within a network device, in accordance with an embodiment of the invention. Referring to FIG. 3A, there is shown a flow chart 300 comprising a plurality of exemplary steps for supporting network proxy services within a network device for energy efficient networking.

In step 302, it may be determined that at least some components in a network device may transition to corresponding power saving states. For example, in the network device 200, the host 204, the NIC 204, and/or any components thereof (e.g. OS 202d) may transition to corresponding power saving states. In this regard, the components transitioning to power saving states, or any functions and/or subcomponents thereof, may be shut down, disabled, and/or run at minimal power. In step 304, network proxying services may be provided for the components and/or subsystems transitioning to power saving states. For example, the proxying servicer module 206 may provide network proxying services in the network device 200. In step 306, network traffic sent by and/or destined for serviced components may be handled, BY the proxying servicer module 206, for example. In step 308, serviced components may be transition from power saving states, to corresponding active states, in instances when such transitions may be determined, via the proxying servicer module 206 for example, to be necessary. Transitioning from power saving states may be triggered by and/or based on, for example, type and/or characteristics of network traffic handled via the proxying servicer module 206. In this regard, the handled network traffic may necessitate transitioning a serviced component from a power-saving state to an active state in such instances as with some management traffic and/or with network traffic carrying data, which must be handled directly by the serviced components and thus require the serviced components to be in active state to be able to handle that traffic.

FIG. 3B is a flow chart that illustrates exemplary steps for providing network proxy services by a network device to other network devices, in accordance with an embodiment of the invention. Referring to FIG. 3B, there is shown a flow chart 330 comprising a plurality of exemplary steps for supporting network proxy services by a network device for a plurality of network devices for energy efficient networking.

In step 332, a network device may be selected from among a plurality of network devices to provide network proxying services to other network devices. For example, the network device 224 may be selected to provide network proxying serviced to the network devices 222a-222n. In step 334, each serviced network devices may be transitioned to a corresponding one of a plurality of power saving states, and the servicing network device may be informed of that transition. In this regard, the transition may be triggered by the servicing network device itself, based on determination, by the servicing network device and/or the serviced device, of the existence and/or the occurrence of one or more conditions permitting or necessitating that change. Transitioning to power saving states may also be performed autonomously within the serviced network devices, and the servicing network device may be informed of the transition thereafter. In step 336, network traffic sent by and/or destined for serviced devices may be handled in the servicing device. For example, proxying servicer module 206 may handled at least some of the network traffic, such as discovery related traffic, which correspond to one or more of the network devices 222a-222n that may have transitioned to power saving states. In step 338, serviced devices may transition from power saving states to corresponding active states in instances when such transitioning may be deemed necessary. For example, the network device 222a may need to be transitioned from a power-saving state to a corresponding active state in such instances, for example, where the proxying servicer module 206 may be unable and/or not permitted to handle the network traffic, such as when the network traffic must be handled directly by the serviced network device (e.g. actual data and/or at least some management traffic).

Various embodiments of the invention may comprise a method and system for network proxy services for energy efficient networking. The network device 224 may provide, via the network proxying servicer module 226, network proxy services to one or more resources internal to the network device 224, such as the host 204 or any subcomponents thereof, and/or to one or more of the network devices 222a-222n, which may transition to one or more corresponding power saving states. The power saving states may comprise disabling, shutting down, and/or reducing power consumption of the serviced resources in the network device 224 and/or network devices 222a-222n. The network proxy service may comprise handling at least some of network communication pertaining to serviced internal components and/or resources in the network device 224, and/or network devices 222a-222n; monitoring for conditions requiring transitioning the serviced resources in the network device 224 and/or network devices 222a-222n from the power saving states; and/or transitioning the serviced resources in the network device 224 and/or the network devices 222a-222n from the power saving states based on that monitoring. The via the network proxying servicer module 226 may be provided imbedded into a network interface controller (NIC) in the network device 224, and/or it may comprise a dedicated component and/or subsystem in the network device 224. Determining when to transition serviced resources in the network device 224 and/or network devices 222a-222n from power saving states may be based on monitoring and/or processing of traffic handled on behalf of the serviced resources in the network device 224 and/or network devices 222a-222n during the network proxy servicing. In this regard, transitioning from power saving states may be performed when handled traffic may comprise actual data and/or management messages. The serviced resources in the network device 224 and/or the network devices 222a-222n may remain in power saving states when handled traffic comprises discovery related traffic. The network proxying servicer module 226 may trigger transitioning the serviced resources in the network device 224 and/or network devices 222a-222n to power saving states.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for network proxy services for energy efficient networking.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method comprising:
in a network device that services one or more resources internal to said network device and/or one or more other network devices:
handling network communication for said one or more internal resources and/or said one or more other network devices in instances when said one or more internal resources and/or said one or more other network devices are operating in corresponding power saving states;
monitoring for conditions that indicate when at least one of said one or more internal resources and/or at least one of said one or more other network devices should transition from said corresponding power saving states; and
initiating said transition of said at least one of said one or more internal resources and/or said at least one of said one or more other network devices from said corresponding power saving states based on said monitoring.

2. The method according to claim 1, wherein said corresponding power saving states comprise disabling, shutting down, and/or reducing power consumption of said one or more internal resources and/or said one or more other network devices.

3. The method according to claim 1, wherein said network device and said one or more other network devices comprise mobile networking devices, personal computers (PCs), servers, and/or network switches.

4. The method according to claim 1, comprising providing said servicing via a network interface controller (NIC) in said network device.

5. The method according to claim 1, comprising determining when to perform said transition from said corresponding power saving states based on monitoring and/or processing of traffic handled in said network device, wherein said traffic is sent from and/or destined for said one or more resources internal to said network device and/or said one or more other network devices.

6. The method according to claim 5, comprising performing said transition from said corresponding power saving states when said handled traffic comprises actual data and/or management messages.

7. The method according to claim 5, comprising keeping said one or more resources internal to said network device and/or said one or more other network devices in said corresponding power saving states when said handled traffic comprises discovery related traffic.

8. The method according to claim 1, comprising maintaining via said network device context data corresponding to said one or more other network devices, wherein said context data is utilized during said servicing via said network device.

9. The method according to claim 1, comprising placing via said network device, at least some of said one or more other network devices into said corresponding power saving states.

10. The method according to claim 1, comprising waking up via said network device at least some of said one or more other network devices during said transition from said corresponding power saving states.

11. A system comprising:
one or more circuits and/or processors for use in a network device that services one or more resources internal to said network device and/or one or more other network devices, said one or more circuits and/or processors being operable to:
handle network communication for said one or more internal resources and/or said one or more other network devices in instances when said one or more internal resources and/or said one or more other network devices are operating in corresponding power saving states;
monitor for conditions that indicate when at least one of said one or more internal resources and/or at least one of said one or more other network devices should transition from said corresponding power saving states; and
initiate said transition of said at least one of said one or more internal resources and/or said at least one of said one or more other network devices from said corresponding power saving states based on said monitoring.

12. The system according to claim 11, wherein said corresponding power saving states comprise disabling, shutting down, and/or reducing power consumption of said one or more internal resources and/or said one or more other network devices.

13. The system according to claim 11, wherein said network device and said one or more other network devices comprise mobile networking devices, personal computers (PCs), servers, and/or network switches.

14. The system according to claim 11, wherein said one or more circuits and/or processors are operable to provide said servicing via a network interface controller (NIC) in said network device.

15. The system according to claim 11, wherein said one or more circuits and/or processors are operable to determine when to perform said transition from said corresponding power saving states based on monitoring and/or processing of traffic handled in said network device, wherein said traffic is sent from and/or destined for said one or more resources internal to said network device and/or said one or more other network devices.

16. The system according to claim 15, wherein said one or more circuits and/or processors are operable to perform said transition from said corresponding power saving states when said handled traffic comprises actual data and/or management messages.

17. The system according to claim 15, wherein said one or more circuits and/or processors are operable to keep said one or more resources internal to said network device and/or said one or more other network devices in said corresponding power saving states when said handled traffic comprises discovery related traffic.

18. The system according to claim 11, wherein said one or more circuits and/or processors are operable to maintain in said network device context data corresponding to said one or more other network devices, wherein said context data is utilized during said servicing via said network device.

19. The system according to claim 11, wherein said one or more circuits and/or processors are operable to place at least some of said one or more other network devices into said corresponding power saving states.

20. The system according to claim 11, wherein said one or more circuits and/or processors are operable to wake up at least some of said one or more other network devices during said transition from said corresponding power saving states.
